(19) United States
(12) Patent Application Publication
(10) Pub. No.: US 2024/0281433 A1
(43) Pub. Date: Aug. 22, 2024

(54) DEVICE, SYSTEM, AND METHOD FOR BULK-ONLY TRANSFER

(71) Applicants: Mohan Kumar JINDAL, Bangalore (IN); Shailja JINDAL, Bangalore (IN)

(72) Inventors: Mohan Kumar JINDAL, Bangalore (IN); Ashish Shridhar JADHAO, Bangalore (IN); Sumit Manoj KAVATHEKAR, Bangalore (IN); Shon Pravin TAWARE, Bangalore (IN); Adithi L, Bangalore (IN); Ravindra Madan LANDE, Bangalore (IN); Sesha Sowjanya BATTULA, Bangalore (IN)

(21) Appl. No.: 18/652,848

(22) Filed: May 2, 2024

Related U.S. Application Data
(63) Continuation-in-part of application No. PCT/IN2024/050105, filed on Feb. 3, 2024.

(51) Int. Cl. G06F 16/23; G06F 16/2455

(52) U.S. Cl. CPC G06F 16/2386; G06F 16/2365; G06F 16/2455

(57) ABSTRACT

Disclosed is a device (106) for bulk-only transfer of data including a query unit (110) and a control unit (112). The query unit (110) is configured to configure the second device (104) based on the set of descriptors received from the first device (102). The control unit (112) identifies a direction of transfer of data between the first device (102) and the second device (104), determines a status of a bulk-input endpoint (120) and a bulk-output endpoint (122) for the transfer of the data between the first device (102) and the second device (104), transfers the plurality of CBWs to the first device (102) and transfers the data between the first device (102) and the second device (104) based on the identified direction.

### TECHNICAL FIELD

The present disclosure relates generally to hardware based electronic circuits. More particularly, the present disclosure relates to a device, a system, and a method for bulk-only transfer.

### BACKGROUND

Bulk data transfer is generally referred to as a software driven method for transferring a large amount of data between a host device and a guest device. Both the devices (i.e., the host device and the guest device) are required to be configured to communicate with each other and transfer commands, requests, instructions, status and data. The software that enables the configuration of the host device and the devices for communicative coupling is commonly known as a driver.

The performance of the driver depends on the processing capability of a general-purpose processor of the host device, which is utilized by a number of other tasks being performed in the host device. Further, as the driver is software driven, it is prone to a number of challenges such as a driver failure (i.e., a corrupt driver configuration), malware attacks, unoptimized or slow processing resulting in slow or no data transfer, and the like.

Thus, a secure driver system with a dedicated functionality is an ongoing effort, and demands a need for improvised technical solution that overcomes the aforementioned problems.

### SUMMARY

In an aspect of the present disclosure, the BOT device includes a query unit and a control unit coupled to each other. The query unit is configured to receive a set of descriptors from a first device and configure a second device based on the set of descriptors. The control unit is configured to generate, upon configuration of the second device by way of the query unit, a plurality of command block wrappers based on a command block descriptor received from a second device. The control unit is further configured to identify a direction of transfer of data between the first device and the second device based on the plurality of command block wrappers. Furthermore, the control unit is configured to determine a status of a bulk-input endpoint and a bulk-output endpoint for the transfer of the data between the first device and the second device by way of a plurality of command status wrappers received from the first device. Furthermore, the control unit is configured to transfer the plurality of command block wrappers to the first device. Furthermore, the control unit is configured to transfer the data between the first device and the second device based on the identified direction. The query unit and the control unit are implemented on at least one of, a Field Programmable Gate Array (FPGA) and Application Specific Integrated Circuits (ASICs).

In some aspects, the BOT device is further coupled to a protocol unit such that the BOT device by way of the control unit receives a set of Mass Storage Class (MSC) protocols for the transfer of the data between the first device and the second device, from the protocol unit.

In some aspects, upon the transfer of the data between the first device and the second device, the control unit is configured to determine and mitigate one or more errors in the transfer of the data based on at least one of, the plurality of command block wrappers, the plurality of command status wrappers, and the direction of the transfer of the data between the first device and the second device.

In some aspects, the set of descriptors includes a device descriptor, a string descriptor, a configuration descriptor, an interface descriptor, and an endpoint descriptor. The device descriptor includes Universal Serial Bus (USB) specification information of the first device. The string descriptor includes a serial number of the first device such that the serial number includes at least 12 digits. The configuration descriptor includes configuration information of the first device. The interface descriptor includes information of one or more interfaces of the first device. The endpoint descriptor includes information of one or more endpoints of the first device.

In some aspects, to identify the direction of the transfer of the data, the control unit is configured to identify a bit value of a direction bit of each command block wrapper of the plurality of command block wrappers. A size of each command block wrapper of the plurality of command block wrappers is 31 bytes.

In some aspects, to determine the status of the transfer of the data between the first device and the second device, the control unit is configured to determine, for each command status wrapper of the plurality of command status wrappers, a status of a stall condition, a validity, and a value of a phase error. A size of each command status wrapper of the plurality of command status wrappers is 13 bytes.

In another aspect of the present disclosure, the system includes a first device communicatively coupled to a second device via a bulk-only transfer (BOT) device. The first device is configured to send a set of descriptors and a plurality of command status wrappers to the BOT device. The second device is configured to send a command block descriptor to the BOT device. The BOT device includes a query unit coupled to a control unit. The query unit is configured to receive the set of descriptors from the first device and configure the second device based on the set of descriptors. The control unit is configured to generate, upon configuration of the second device by way of the query unit, a plurality of command block wrappers (CBWs) based on the command block descriptor received by the second device. The control unit is further configured to identify a direction of transfer of data between the first device and the second device based on the plurality of CBWs. Furthermore, the control unit is configured to determine a status of a bulk-input endpoint and/or a status of a bulk-output endpoint for the transfer of the data between the first device and the second device by way of a plurality of command status wrappers (CSWs) received from the first device. Furthermore, the control unit is configured to transfer the plurality of CBWs to the first device. Furthermore, the control unit is configured to transfer the data between the first device and the second device based on the identified direction. The query unit and the control unit are implemented on at least one of, a Field Programmable Gate Array (FPGA) and Application Specific Integrated Circuits (ASICs).

In some aspects, the system further includes a protocol unit that is coupled to the control unit such that the control unit is configured to receive a set of Mass Storage Class (MSC) protocols for the transfer of the data between the first device and the second device from the protocol unit.

In another aspect of the present disclosure, the method includes receiving, a set of descriptors from a first device, and configuring a second device based on the set of descriptors, by way of a query unit. The method further includes generating a plurality of command block wrappers based on a command block descriptor received from a second device, and identifying a direction of transfer of data between the first device and the second device based on the plurality of CBWs, by way of the control unit. Furthermore, the method includes determining, by way of the control unit, a status of a bulk-input endpoint and a bulk-output endpoint for the transfer of the data between the first device and the second device based on a plurality of command status wrappers (CSWs) received from the first device. Furthermore, the method includes transferring the plurality of CBWs to the first device, and transferring the data between the first device and the second device based on the identified direction of the transfer of the data, by way of the control unit. The query unit and the control unit are implemented on at least one of, a Field Programmable Gate Array (FPGA) and Application Specific Integrated Circuits (ASICs).

In some aspects, the method further includes receiving, by way of the control unit, a set of Mass Storage Class (MSC) protocols for the transfer of the data between the first device and the second device, from the protocol unit.

In some aspects, upon determining the status of the transfer of the data, the method includes determining and mitigating, one or more errors in the transfer of the data based on the plurality of CBWs, the plurality of CSWs, and the direction of the transfer of the data.

In some aspects, to identify the direction of the transfer of the data, the method includes identifying a bit value of a direction bit of each command block wrapper of the plurality of CBWs.

In some aspects, to determine the status of the transfer of the data between the first device and the second device, the method includes determining, for each CSW of the plurality of CSWs, a status of a stall condition, a validity, and a value of a phase error.

### BRIEF DESCRIPTION OF DRAWINGS

The above and still further features and advantages of aspects of the present disclosure becomes apparent upon consideration of the following detailed description of aspects thereof, especially when taken in conjunction with the accompanying drawings, and wherein:

FIG. 1 illustrates a block diagram of a system for bulk-only transport, in accordance with an aspect of the present disclosure;

FIG. 2 illustrates a block diagram of a Bulk-Only Transport (BOT) device of FIG. 1, in accordance with an aspect of the present disclosure;

FIG. 3 illustrates a flow chart of a method for bulk-only transport, in accordance with an aspect of the present disclosure; and

FIG. 4 illustrates a flow chart of a method for determining a status of a bulk-input endpoint and a bulk-output endpoint for a transfer of data of FIG. 3, in accordance with an aspect of the present disclosure.

To facilitate understanding, like reference numerals have been used, where possible, to designate like elements common to the figures.

### DETAILED DESCRIPTION

Various aspect of the present disclosure provides a secure device, a system, and a method for bulk-only transfer of data. The following description provides specific details of certain aspects of the disclosure illustrated in the drawings to provide a thorough understanding of those aspects. It should be recognized, however, that the present disclosure can be reflected in additional aspects and the disclosure may be practiced without some of the details in the following description.

The various aspects including the example aspects are now described more fully with reference to the accompanying drawings, in which the various aspects of the disclosure are shown. The disclosure may, however, be embodied in different forms and should not be construed as limited to the aspects set forth herein. Rather, these aspects are provided so that this disclosure is thorough and complete, and fully conveys the scope of the disclosure to those skilled in the art. In the drawings, the sizes of components may be exaggerated for clarity.

It is understood that when an element or layer is referred to as being “on,” “connected to,” or “coupled to” another element or layer, it can be directly on, connected to, or coupled to the other element or layer or intervening elements or layers that may be present. As used herein, the term “and/or” includes any and all combinations of one or more of the associated listed items.

The subject matter of example aspects, as disclosed herein, is described with specificity to meet statutory requirements. However, the description itself is not intended to limit the scope of this patent. Rather, the inventor/inventors have contemplated that the claimed subject matter might also be embodied in other ways, to include different features or combinations of features similar to the ones described in this document, in conjunction with other technologies. Generally, the various aspects including the example aspects relate to a device, a system, and a method for bulk-only transfer of data.

As mentioned, there remains a need for a secure system with a dedicated functionality for bulk-only transfer of data. The present aspect, therefore: provides a secure device, a system, and a method with a dedicated functionality for bulk-only transfer of data.

The aspects herein and the various features and advantageous details thereof are explained more fully with reference to the non-limiting aspects that are illustrated in the accompanying drawings and detailed in the following description. Descriptions of well-known components and processing techniques are omitted so as to not unnecessarily obscure the aspects herein. The examples used herein are intended merely to facilitate an understanding of ways in which the aspects herein may be practiced and to further enable those of skill in the art to practice the aspects herein. Accordingly, the examples should not be construed as limiting the scope of the aspects herein.

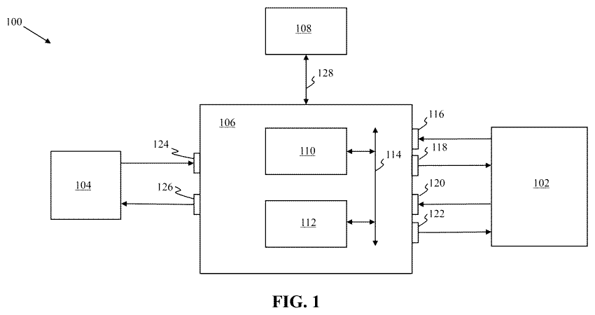

FIG. 1 illustrates a block diagram of a system 100 for bulk-only transport of data, in accordance with an aspect of the present disclosure. The system 100 may include a first device 102, a second device 104, and a Bulk-Only Transfer (BOT) device 106. The BOT device 106 (hereinafter interchangeably referred to and designated as “the device 106”) may enable a communicative coupling between the first device 102 and the second device 104. In some aspects of the present disclosure, the first device 102 may be configured as a peripheral device that may be capable of transferring data. Examples of the first device 102 may include, but not limited to, a Universal Serial Bus (USB) pen drive, a USB flash drive, a USB thump drive, a USB jump drive, a USB stick, and the like. Aspects of the present disclosure are intended to include and/or otherwise cover any type of the first device 102 that is capable of transferring data, commands and/or instructions, including known, related, and later developed devices, without deviating from the scope of the present disclosure.

The first device 102 may be coupled with the BOT device 106. The first device 102 may include suitable circuitry that can be configured to perform one or more operations. For example, the input device 102 may be configured to transfer a set of descriptors to the BOT device 106. In some aspects of the present disclosure, the set of descriptors may include a device descriptor, a string descriptor, a configuration descriptor, an interface descriptor, and an endpoint descriptor. The device descriptor may include USB specification information of the first device 102. The string descriptor may include a serial number of the first device 102 such that the serial number may include at least 12 digits. The configuration descriptor may include configuration information of the first device 102. The interface descriptor may include information of one or more interfaces of the first device 102. The endpoint descriptor may include information of one or more endpoints of the first device 102.

The first device 102 may further be configured to transfer a plurality of Command Status Wrappers (CSWs) to the device 106. Preferably, a size of each CSW of the plurality of CSWs may be 13 bytes. In some aspects of the present disclosure, each CSW may include a CSW signature, a CSW tag, a CSW residue, and a CSW status. Preferably, each CSW of the plurality of CSWs may have the CSW signature that may be assigned to first four bytes of the CSW, the CSW tag that may be assigned to bytes 5-8 of the CSW, the CSW residue that may be assigned to bytes 9-12 of the CSW, and the CSW that may be assigned to a thirteenth byte of the CSW.

The CSW signature may include a Unique Identification (ID) value for the CSW. Preferably, the CSW signature may include a value 53425355h (little endian) that may indicate the CSW. The CSW tag may include a tag for the CSW. In some aspects of the present disclosure, the CSW tag may associate the CSW with a corresponding

CBW such that the first device 102 may echo with the second device 104 through the CSW tag. The CSW residue may include a value of a difference between an expected size of data and an actual of transfer of data. The CSW status may indicate a status of the transfer of the data (i.e., the transfer of the data successful or the transfer of the data failed).

In some aspects of the present disclosure, the second device 104 may be coupled to the device 106 and a computing device (not shown). The second device 104 may include suitable circuitry that can be configured to perform one or more operations. For example, the second device 104 may be configured as a Small Computer System Interface (SCSI) and may be coupled to the computing device that may further have storage and processing capabilities. Examples of the second device 104 may include, but not limited to a hard drive, a compact disc random-access memory (CD-ROM) drive, a tape drive, a scanning drive and the like. Aspects of the present disclosure are intended to include and/or otherwise cover any type of the second device 104 that is capable of transferring data, commands and/or instructions, including known, related, and later developed devices, without deviating from the scope of the present disclosure. The second device 104 may be configured to transfer a command block descriptor to the device 106.

The BOT device 106 may include a query unit 110 and a control unit 112 coupled to each other by way of a first communication bus 114. In some aspects of the present disclosure, the query unit 110 and the control unit 112 may be implemented on at least one of, a Field Programmable Gate Array (FPGA) and Application Specific Integrated Circuits (ASICs). The implementation of query unit 110 and the control unit 112 by the at least one of, a Field Programmable Gate Array (FPGA) and Application Specific Integrated Circuits (ASICs) may facilitate to reduce number driver failures (i.e., lower number of corrupt driver configuration), security from one or more malware attacks in the transfer of the data, and higher speed of the transfer of the data. FPGA and ASICs provide high flexibility and can be reprogrammed, which allows for rapid prototyping and development cycles. FPGAs can be customized to meet specific requirements by adding or removing functionality. Thus, the implementation using FPGA and/or ASICs can be optimized for specific applications, and can result in high performance and low power consumption.

The device 106 may further include a command-input endpoint 116, a command-output endpoint 118, a bulk-input endpoint 120, and a bulk-out endpoint 122. The command-input endpoint 116 may include suitable circuitry that can be configured to perform one or more operations. For example, the command-input endpoint 116 may be configured to receive the plurality of CSWs from the first device 102. In other words, the command-input endpoint 116 may enable the device 106 to receive the plurality of CSWs from the first device 102 such that upon reception of the plurality of CSWs, the command-input endpoint 116 provides the plurality of CSWs to the query unit 110.

The command-output endpoint 118 may include suitable circuitry that can be configured to perform one or more operations. For example, the command-output endpoint 118 may be configured to receive the plurality of CBWs from the control unit 112 and may further provide the plurality of CBWs to the first device 102.

The bulk-input endpoint 120 may include suitable circuitry that can be configured to perform one or more operations. For example, the bulk-input endpoint 120 may enable the device 106 to receive the data from the first device 102. In other words, the bulk-input endpoint 120 may enable the device 106 to receive the data from the first device 102 such that upon reception of the data, the bulk-input endpoint 120 provides the data to the control unit 112.

The bulk-out endpoint 122 may include suitable circuitry that can be configured to perform one or more operations. For example, the bulk-output endpoint 122 may be configured to receive the data from the control unit 112 and may further provide the data from the control unit 1112 to the first device 102.

In some aspects of the present disclosure, the device 106 may further include a data-input endpoint 124 and a data-output endpoint 126. The data-input endpoint 124 may facilitate to couple the device 106 with the second device 104. Further, the data-input endpoint 124 may include suitable circuitry that can be configured to perform one or more operations. For example, the data-input endpoint 124 may be configured to receive the data from the second device 104 and may further provide the data to the control unit 112. Specifically, the data-input endpoint 124 may be configured to receive the command descriptor block from the second device 104 and may further provide the command descriptor block to the control unit 112. The data-output endpoint 126 may facilitate to couple the device 106 to the second device 104. Specifically, the data-output endpoint 126 may include suitable circuitry that can be configured to perform one or more operations. For example, the data-output endpoint 126 may be configured to receive the data from the control unit 112 and may further provide the data to the second device 104. Specifically, the data-output endpoint 126 may receive the plurality of CSWs from the control unit 112 and may further provide the plurality of CSWs to the second device 104.

The query unit 110 may be configured to receive the set of descriptors from the first device 102. In some aspects of the present disclosure, the query unit 110 may further be configured to configure the second device 104 based on the set of descriptors. The control unit 112, upon configuration of the second device 104 may be configured to a generate a plurality of command block wrappers (CBWs) based on the command block descriptor received by the second device 104. Preferably, a size of each command block wrapper (CBW) of the plurality of CBWs may be 31 bytes. In some aspects of the present disclosure, each CBW may include a CBW signature, a CBW tag, a CBW transfer length (CBWTL), a set of CBW flags, a CBW logical unit number (CBWLUN), a CBW length, and a CBW command block. Preferably, each CBW of the plurality of the command block wrappers may have the CBW signature assigned to a first four bytes (i.e., 1-4 bytes) of the CBW, the CBW tag may be assigned to bytes 5-8 of the CBW, the CBWTL may be assigned to bytes 9-12 of the CBW, the set of CBW flags may be assigned to the thirteenth byte of the CBW, the CBWLUN may be assigned to the first nibble (i.e., the first four bits) of the fourteenth byte of the CBW, the CBW length may be assigned to the first five bits of the fifteenth byte of the CBW, and the CBWCB may be assigned to the bytes 16-31 of the CBW.

The CBW signature may include a unique ID value for the CBW. Preferably the CBW signature may include a value 43425355h (little endian) that may indicate the CBW. The CBW tag may include a tag for the CBW sent by the second device 104. The CBW tag may be set to the value associated with the CBW. In some aspects of the present disclosure, the CBW tag value may be same as the CSW tag value. The CBWTL may include a number of bytes of the data expected by the second device 104. In some aspects of the present disclosure a zero value of the CBWTL may indicate no transfer of the data between the first device 102 and the second device 104. The set of CBW flags may include a direction bit that may indicate a direction of the transfer of the data between the first device 102 and the second device 104. Preferably, the eighth bit of the CBW flag may be designated as the direction bit. In some aspects of the present disclosure, when the direction bit is set to a bit value ‘1’, the direction of the transfer of the data may be from the second device 104 to the first device 102. When instead the direction bit is set to a bit value ‘0’, the direction of the transfer of the data may be from the first device 102 to the second device 104.

The set of CBW flags may further include an obsolete bit that may be set to the bit value ‘0’ by the second user 104. Furthermore, the set of flags may include a set of reserved bits, that may be set to the bit value ‘0’ by the second device 104. Preferably, a size of the set of reserved bits may be six bits. In some aspects of the present disclosure, each reserved bit of the set of reserved bits may be set to the bit value ‘0’ by the second device 104. When the second device 104 supports more than one logical unit, the CBWLUN may include information of the more than one logical unit. When instead the second device 104 supports only one logical unit, the second device 104 may set the value of the CBWLUN to the bit value ‘0’. The CBW length may indicate a valid length of the CBW in bytes. The CBW command block may indicate the CBW as defined by a command set of an interface sub-class. The CBW, by way of the CBW signature may indicate an association of each CBW with a corresponding CSW.

In some aspects of the present disclosure, the control unit 112 may further be configured to identify the direction of transfer of data between the first device 102 and the second device 104 based on the plurality of CBWs. The control unit 112 may be configured to identify a value of the eighth bit of the CBW flag (i.e., the direction bit) of each CBW to determine the direction of the transfer of the data between the first device 102 and the second device 104. Furthermore, the control unit 112 may be configured to determine a status of the bulk-input endpoint 120 and a bulk-output endpoint 122 for the transfer of the data between the first device 102 and the second device 104. In some aspects of the present disclosure, the control unit 112 may be configured to determine the status of the bulk-input endpoint 120 and the bulk-out endpoint by way of the plurality of CSWs received from the first device 102. Furthermore, the control unit 112 may be configured to transfer the plurality of CBWs to the first device 102. Furthermore, the control unit 112 may be configured to transfer the data between the first device 102 and the second device 104 based on the direction of the transfer of the data determined by way of the identified value of the eighth bit of the CBW flag (i.e., the direction bit) of each CBW of the plurality of CBWs.

In some aspects of the present disclosure, upon the transfer of the data between the first device 102 and the second device 104, the control unit 112 may be configured to determine and mitigate one or more errors in the transfer of the data based on at least one of, the plurality of CBWs, the plurality of CSWs, and the direction of the transfer of the data between the first device 102 and the second device 104. In some aspects of the present disclosure, to mitigate the one or more errors, the control unit 112 may be configured to determine and/or identify for each CSW of the plurality of the command status wrapper, a status of a validity and a value of a phase error.

In some aspects of the present disclosure, the system 100 may further include a protocol unit 108 such that the protocol unit 108 may be coupled to the device 106 by way of a second communication bus 128. Preferably, the protocol unit 108 may be coupled to the control unit 112 of the device 106. In some aspects of the present disclosure, the protocol unit 108 may be configured to transfer a set of Mass Storage Class (MSC) protocols to the device 106 for the transfer of the data between the first device 102 and the second device 102.

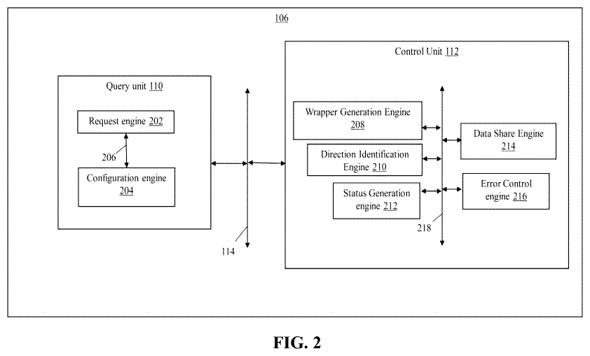

FIG. 2 illustrates a block diagram of the BOT device 106 of FIG. 1, in accordance with an aspect of the present disclosure. The device 106 may include the query unit 110 and the control unit 112 coupled to each other by way of the first communication bus 114. In some aspects of the present disclosure, the query unit 110 may include a request engine 202 and a configuration engine 204 communicatively coupled to each other by way of a third communication bus 206. The request engine 202 may be configured to send requests to the first device 102 to share the set of descriptors with the BOT 106 by way of the command-input endpoint 116. In some aspects of the present disclosure, the request engine 202 may be configured to send requests to the first device by way of the command-input endpoint 116 to share one or more of the device descriptors, the string descriptor, the configuration descriptor, the interface descriptor, and the endpoint descriptor of the first device 102. The request engine 202 may further be configured to receive the set of descriptors from the first device 102 by way of the command-output endpoint 118. In some aspects of the present disclosure, the request engine 202 may be configured to receive one or more of the device descriptors, the string descriptor, the configuration descriptor, the interface descriptor, and the endpoint descriptor of the first device 102 by way of the command-output endpoint 118. The configuration engine 204, may be configured to adjusting a plurality of interface parameters of the second device 104 to configure the second device 104 based on the set of descriptors received from the first device 102. The configuration of the second device 104 may enable communicative coupling between the first device 102 and the second device 104.

In some aspects of the present disclosure, the control unit 112 may include a wrapper generation engine 208, a direction identification engine 210, a data a status generation engine 212, a data share engine 214, and an error control engine 216 communicatively coupled to each other by way of a fourth communication bus 218. The wrapper generation engine 208 may be configured to receive the command block descriptor from the second device 104 by way of the data-input endpoint 124. The wrapper generation engine 208 may further be configured to generate the plurality of CBWs from the command block descriptor. Preferably, the wrapper generation engine 208 may be configured to generate the plurality of CBWs such that the size of each CBW is 13 bytes. The direction identification engine 210 may be configured to identify the direction of the transfer of the data based on the plurality of the command block wrappers. Preferably, the direction identification engine 210 may be configured to identify the direction of the transfer of the data based on the value of the eighth bit of the CBW flag (i.e., the direction bit) of each CBW of the plurality of CBWs. The status generation engine 212 may be configured to determine the status of the bulk-input endpoint 120 and/or the status of the bulk-output endpoint 122 for the transfer of the data between the first device 102 and the second device 104. In some aspects of the present disclosure, the status generation engine 212 may be configured to determine the status of the bulk-input endpoint 120 and/or the status of the bulk-output endpoint 122 by way of the plurality of CSWs received from the first device 102. The data share engine 214 may be configured to transfer the data from the first device 102 and the second device 104 by way of the bulk-input endpoint 120 and/or from the second device 104 and the first device 102 by way of the bulk-output endpoint 122, based on the direction of the transfer of the data. The error control engine 216 may be configured to determine the one or more errors in the transfer of the data based on the plurality of CBWs, the plurality of CSWs, and the direction of the transfer of the data between the first device 102 and the second device 104. The error engine 216 may further be configured to mitigate the one or more errors in the transfer of the data.

In some aspects of the present disclosure, the control unit (112) may be configured to determine and mitigate one or more errors in the transfer of the data based on at least one of the plurality of CBWs, the plurality of CSWs, and the direction of the transfer of the data between the first device (102) and the second device (104). To determine the one or more errors in the transfer of the data between the first device 102 and the second device 104, the error control engine may be configured to determine the status of the validity of each CBW of the plurality of the command block wrappers. The error control engine 216 may further be configured to determine the value of the phase error for each CSW of the plurality of CSWs. The control error engine 216 may further be configured to determine a status of the phase error for each CSW of the plurality of CSWs based on the value of the phase error for each CSW of the plurality of CSWs.

Furthermore, the error control engine 216 may be configured to compare the value of the phase error for each CSW of the plurality of CSWs with a predefined threshold value.

The error control engine 216 may be configured to determine a type of error for each error of the one or more errors. The error control engine 216 may further be configured to generate an alert that is specific to the type of error for each error of the one or more errors. The error control engine 216 may further be configured to send information of the one or more errors to the first device 102 and/or the second device 104.

In some aspects of the present disclosure, the device 106 may further include a memory unit (not shown) configured to store one or more instructions, commands and the data from the first device 102 and the second device 104. Examples of the memory unit may include but are not limited to, a ROM, a RAM, a flash memory, a removable storage drive, a HDD, a solid-state memory, a magnetic storage drive, a PROM, an EPROM, an EEPROM and the like. Aspects of the present disclosure are intended to include and/or otherwise cover any type of the memory unit that is capable of storing data, commands and/or instructions, including known, related, and later developed devices, without deviating from the scope of the present disclosure.

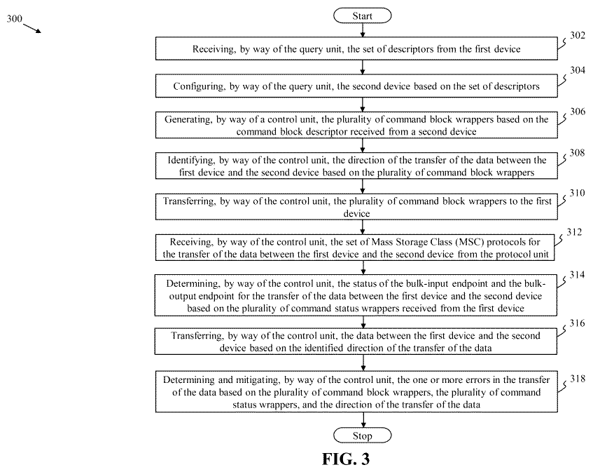

FIG. 3 illustrates a flow chart of a method 300 for bulk-only transport, in accordance with an exemplary aspect of the present disclosure.

At step 302, the system 100, by way of the query unit 110 of the BOT device 106 may receive the set of descriptors from the first device 102.

At step 304, the system 100, by way of the query unit 110 may configure the second device 104 based on the set of descriptors received from the first device 102. In some aspects of the present disclosure, the system 100 may configure the second device 104 to enable communicative coupling of the second device with the first device 102.

At step 306, the system 100, by way of the control unit 112 of the BOT device 106 generate the plurality of CBWs based on the command block descriptor received from a second device.

At step 308, the system 100, by way of the control unit 112 may identify the direction of the transfer of the data between the first device 102 and the second device 104 based on the plurality of CBWs. In some aspects of the present disclosure, the system 100 may be configured to identify the direction of the transfer of the data by identifying the value of the eighth bit of the CBW flag (i.e., the direction bit) of each CBW of the plurality of CBWs.

At step 310, the system 100, by way of the control unit 112 may transfer the plurality of CBWs to the first device 102.

At step 312, the system 100, by way of the control unit 112 may receive the set of Mass

Storage Class (MSC) protocols for the transfer of the data between the first device and the second device from the protocol unit 108.

At step 314, the system 100, by way of the control unit 112 may determine the status of the bulk-input endpoint 120 and the status of the bulk-output endpoint 122 for the transfer of the data between the first device 102 and the second device 104 based on the plurality of CSWs received from the first device 102.

At step 316, the system 100, by way of the control unit 112 may transfer the data between the first device 102 and the second device 104 based on the identified direction of the transfer of the data. In some aspects of the present disclosure, the transfer of the data between the first device 102 and the second device 104 may be based on the set of Mass Storage Class (MSC) protocols received from the protocol unit 108.

At step 318, the system 100, by way of the control unit 112 may determine the one or more errors in the transfer of the data based on the plurality of CBWs, the plurality of CSWs, and the direction of the transfer of the data. Based on the determination of the one or more errors, the system 100 may further mitigate the one or more errors.

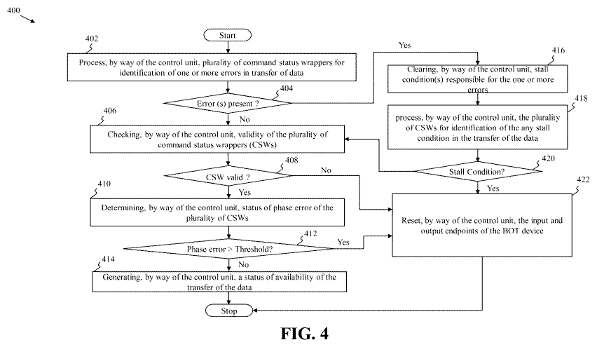

FIG. 4 illustrates a flow chart of a method 400 for determining the status of a bulk-input endpoint 120 and the bulk-output endpoint 122 for the transfer of the data of FIG. 3, in accordance with an exemplary aspect of the present disclosure.

At step 402, the system 100, by way of the control unit 112, may process the plurality of CSWs for identification of the one or more errors in the transfer of the data.

At step 404, when the system 100 determines that at least an error of the one or more errors is not detected, the method 400 may proceed to a step 404, otherwise the method 400 may proceed to a step 416.

At step 406, the system 100 may determine a status of the validity of the plurality of CSWs. The status of the validity may either be ‘valid’ of ‘invalid’.

At step 408, when the system 100 determines the status of the validity of the plurality of CSWs to be valid, the method 400 may proceed to a step 410, otherwise the method 400 may proceed to a step 422.

At step 410, the system 100 may determine the value of the phase error of each CSW of the plurality of CSWs.

At step 412, when the system 100 determines the value of the phase error less than a threshold value, the method 400 may proceed to a step 414, otherwise the method 400 may proceed to a step 422.

At step 414, the system 100 may generate a status of availability of the transfer of the data.

At step 416, the system 100 may identify one or more stall conditions responsible for the one or more errors in the transfer of the data. The system 100 may further clear the one or more stall conditions responsible for the one or more errors in the transfer of the data.

At step 418, the system 100 may process the plurality of CSWs for identification of the any pending stall condition in the transfer of the data.

At step 420, when the system 100 determines any pending stall condition in the transfer of the data, the method 400 may proceed to step 422, otherwise the method 400 may proceed to the step 406.

At step 422, the system 100 may reset the bulk-input endpoint 120 and bulk-output endpoint 122 of the BOT device 106.

Thus, the implementation of query unit 110 and the control unit 112 by the at least one of, a Field Programmable Gate Array (FPGA) and Application Specific Integrated Circuits (ASICs) may result in advantages such as reduced number driver failures (i.e., lower number of corrupt driver configuration), security from one or more malware attacks in the transfer of the data, higher speed of the transfer of the data, and the like. As will be readily apparent to those skilled in the art, aspects of the present disclosure may easily be produced in other specific forms without departing from their essential characteristics. Aspects of the present disclosure are, therefore, to be considered as merely illustrative and not restrictive, the scope being indicated by the claims rather than the foregoing description, and all changes which come within therefore intended to be embraced therein.

The foregoing discussion of the present disclosure has been presented for purposes of illustration and description. It is not intended to limit the present disclosure to the form or forms disclosed herein. In the foregoing Detailed Description, for example, various features of the present disclosure are grouped together in one or more aspects, configurations, or aspects for the purpose of streamlining the disclosure. The features of the aspects, configurations, or aspects may be combined in alternate aspects, configurations, or aspects other than those discussed above. This method of disclosure is not to be interpreted as reflecting an intention the present disclosure requires more features than are expressly recited in each claim. Rather, as the following claims reflect, inventive aspects lie in less than all features of a single foregoing disclosed aspect, configuration, or aspect. Thus, the following claims are hereby incorporated into this Detailed Description, with each claim standing on its own as a separate aspect of the present disclosure.

Moreover, though the description of the present disclosure has included description of one or more aspects, configurations, or aspects and certain variations and modifications, other variations, combinations, and modifications are within the scope of the present disclosure, e.g., as may be within the skill and knowledge of those in the art, after understanding the present disclosure. It is intended to obtain rights which include alternative aspects, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

As one skilled in the art will appreciate, the system 100 includes a number of functional blocks in the form of a number of units and/or engines. The functionality of each unit and/or engine goes beyond merely finding one or more computer algorithms to carry out one or more procedures and/or methods in the form of a predefined sequential manner, rather each engine explores adding up and/or obtaining one or more objectives contributing to an overall functionality of the system 100. Each unit and/or engine may not be limited to an algorithmic and/or coded form, rather may be implemented by way of one or more hardware elements operating together to achieve one or more objectives contributing to the overall functionality of the system 100. Further, as it will be readily apparent to those skilled in the art, all the steps, methods and/or procedures of the system 100 are generic and procedural in nature and are not specific and sequential.

Certain terms are used throughout the following description and claims to refer to particular features or components. As one skilled in the art will appreciate, different persons may refer to the same feature or component by different names. This document does not intend to distinguish between components or features that differ in name but not structure or function. While various aspects of the present disclosure have been illustrated and described, it will be clear that the present disclosure is not limited to these aspects only. Numerous modifications, changes, variations, substitutions, and equivalents will be apparent to those skilled in the art, without departing from the spirit and scope of the present disclosure, as described in the claims.

1. A Bulk-Only Transfer (BOT) device (106) comprising:
a query unit (110) configured to (i) receive a set of descriptors from a first device (102) and (ii) configure a second device (104) based on the set of descriptors; and
a control unit (112) coupled to the query unit (110) and configured to:
generate, upon configuration of the second device (104) by way of the query unit (110), a plurality of command block wrappers based on a command block descriptor received from a second device (104);
identify a direction of transfer of data between the first device (102) and the second device (104) based on the plurality of CBWs;
determine a status of a bulk-input endpoint (120) and a bulk-output endpoint (122) for the transfer of the data between the first device (102) and the second device (104) by way of a plurality of command status wrappers received from the first device (102).
transfer the plurality of CBWs to the first device (102); and
transfer the data between the first device (102) and the second device (104) based on the identified direction;
wherein the query unit (110) and the control unit (112) are implemented on at least one of, a Field Programmable Gate Array (FPGA) and Application Specific Integrated Circuits (ASICs).

2. The BOT device (106) as claimed in claim 1, wherein the BOT device (106) is further coupled to a protocol unit (108) such that the BOT device (106) by way of the control unit (112) receives a set of Mass Storage Class (MSC) protocols for the transfer of the data between the first device (102) and the second device (104), from the protocol unit (108).

3. The BOT device (106) as claimed in claim 1, wherein, upon the transfer of the data between the first device (102) and the second device (104), the control unit (112) is configured to determine and mitigate one or more errors in the transfer of the data based on at least one of (i) the plurality of CBWs, (ii) the plurality of CSWs, and (iii) the direction of the transfer of the data between the first device (102) and the second device (104).

4. The BOT device (106) as claimed in claim 1, wherein the set of descriptors comprising:
a device descriptor comprising Universal Serial Bus (USB) specification information of the first device (102);
a string descriptor comprising a serial number of the first device (102), wherein the serial number comprising at least 12 digits;
a configuration descriptor comprising configuration information of the first device (102);
an interface descriptor comprising information of one or more interfaces of the first device (102); and
an endpoint descriptor comprising information of one or more endpoints of the first device (102).

5. The BOT device (106) as claimed in claim 1, wherein, to identify the direction of the transfer of the data, the control unit (112) is configured to identify a bit value of a direction bit of each command block wrapper of the plurality of CBWs, wherein a size of each command block wrapper of the plurality of CBWs is 31 bytes.

6. The BOT device (106) as claimed in claim 1, wherein, to determine the status of the transfer of the data between the first device (102) and the second device (104), the control unit (112) is configured to determine, for each command status wrapper of the plurality of CSWs, (i) a status of a stall condition, (ii) a validity, and (iii) a value of a phase error, wherein a size of each command status wrapper of the plurality of CSWs is 13 bytes.

7. A system (100) comprising:
a first device (102) configured to transfer a set of descriptors and a plurality of command status wrappers to the BOT device (106);
a second device (104) is configured to transfer a command block descriptor to the BOT device (106); and
a BOT device (106) that is coupled to the first device (102) and the second device (104), the BOT device (106) comprising:
a query unit (112) configured to (i) receive the set of descriptors from the first device (102), and (ii) configure the second device (104) based on the set of descriptors; and
a control unit (112) that is coupled to the query unit (110) and configured to:
generate, upon configuration of the second device (104) by way of the query unit (110), a plurality of command block wrappers based on the command block descriptor received by the second device (104);
identify a direction of transfer of data between the first device (102) and the second device (104) based on the plurality of CBWs;
determine a status of a bulk-input endpoint (120) and a bulk-output endpoint (122) for the transfer of the data between the first device (102) and the second device (104) by way of a plurality of command status wrappers received from the first device (102);
transfer the plurality of CBWs to the first device (102); and
transfer the data between the first device (102) and the second device (104) based on the identified direction;
wherein the query unit (110) and the control unit (112) are implemented on at least one of, a Field Programmable Gate Array (FPGA) and Application Specific Integrated Circuits (ASICs).

8. The system (100) as claimed in claim 7, wherein the control unit (112) further comprising a protocol unit (108) that is coupled to the control unit (112) such that the control unit (112) is configured to receive a set of Mass Storage Class (MSC) protocols for the transfer of the data between the first device (102) and the second device (104) from the protocol unit (108).

9. The system (100) as claimed in claim 7, wherein, upon the transfer of the data, the control unit (112) is configured to determine and mitigate one or more errors in the transfer of the data based on (i) the plurality of CBWs, (ii) the plurality of CSWs, and (iii) the direction of the transfer of the data between the first device (102) and the second device (102).

10. The system (100) as claimed in claim 7, wherein the set of descriptors
comprising: a device descriptor comprising Universal Serial Bus (USB) specification information of the first device (102);
a string descriptor comprising a serial number of the first device (102), such that the serial number comprising at least 12 digits;
a configuration descriptor comprising configuration information of the first device (102);
an interface descriptor comprising information of one or more interfaces of the first device (102); and
an endpoint descriptor comprising information of one or more endpoints of the first device (102).

11. The system (100) as claimed in claim 7, wherein, to identify the direction of the transfer of the data the control unit (112) is configured to identify a bit value of a direction bit of each command block wrapper of the plurality of CBWs, wherein a size of each command block wrapper of the plurality of CBWs is 31 bytes,

12. The system (100) as claimed in claim 7, wherein to determine the status of the transfer of the data between the first device (102) and the second device (104), the control unit (112) is configured to determine, for each command status wrapper of the plurality of CSWs (i) a status of a stall condition, (ii) a validity, and (iii) a value of a phase error, wherein a size of each command status wrapper of the plurality of CSWs is 13 bytes.

13. A method (300) comprising:
receiving, by way of a query unit (110), a set of descriptors from a first device (102);
configuring, by way of the query unit (110), a second device (104) based on the set of descriptors;
generating, by way of a control unit (112), a plurality of command block wrappers based on a command block descriptor received from a second device (104);
identifying, by way of the control unit (112), a direction of transfer of data between the first device (102) and the second device (104) based on the plurality of CBWs;
determining, by way of the control unit (112), a status of a bulk-input endpoint (120) and a bulk-output endpoint (122) for the transfer of the data between the first device (102) and the second device (104) based on a plurality of command status wrappers received from the first device (102);
transferring, by way of the control unit (112), the plurality of CBWs to the first device (102);
transferring, by way of the control unit (112), the data between the first device (102) and the second device (104) based on the identified direction of the transfer of the data; and
wherein the query unit (110) and the control unit (112) are implemented on at least one of, a Field Programmable Gate Array (FPGA) and Application Specific Integrated Circuits (ASICs).

14. The method (300) as claimed in claim 13, wherein, prior to transferring the data between the first device (102) and the second device (104), the method (300) comprising receiving, by way of the control unit (112), a set of Mass Storage Class (MSC) protocols for the transfer of the data between the first device (102) and the second device (104), from the protocol unit (108).

15. The method (300) as claimed in claim 13, wherein, upon determining the status of the transfer of the data, the method (300) comprising determining and mitigating, by way of the control unit (112), one or more errors in the transfer of the data based on the plurality of CBWs, the plurality of CSWs, and the direction of the transfer of the data.

16. The method (300) as claimed in claim 13, wherein the set of descriptors comprising: a device descriptor comprising Universal Serial Bus (USB) specification information of the first device (102);
a string descriptor comprising a serial number of the first device (102), such that the serial number comprising at least 12 digits;
a configuration descriptor comprising configuration information of the first device (102);
an interface descriptor comprising information of one or more interfaces of the first device (102); and
an endpoint descriptor comprising information of one or more endpoints of the first device (102).

17. The method (300) as claimed in claim 13, wherein, to identify the direction of the transfer of the data, the method (300) comprising identifying, by way of the control unit (112), a bit value of a direction bit of each command block wrapper of the plurality of CBWs, wherein a size of each command block wrapper of the plurality of CBWs is 31 bytes.

18. The method (300) as claimed in claim 13, wherein, to determine the status of the transfer of the data between the first device (102) and the second device (104), the method (300) comprising determining, by way of the control unit (112), for each command status wrapper of the plurality of CSWs, (i) a status of a stall condition, (ii) a validity, and (iii) a value of a phase error, wherein a size of each command status wrapper of the plurality of CSWs is 13 bytes.
